(19) United States
(12) Patent Application Publication
(10) Pub. No.: US 2024/0177112 A1
(43) Pub. Date: May 30, 2024

(54) METHOD, APPARATUS, ELECTRONIC DEVICE AND COMPUTER STORAGE MEDIUM FOR ASSIGNING GOODS

(71) Applicant: ZHEJIANG GALAXIS TECHNOLOGY GROUP CO., LTD, Jiaxing (CN)

(72) Inventors: Yan YANG, Jiaxing (CN); Lu SHEN, Jiaxing (CN); Chunguang GU, Jiaxing (CN); Sha LIU, Jiaxing (CN)

(21) Appl. No.: 18/434,909

(22) Filed: Feb. 7, 2024

Related U.S. Application Data
(63) Continuation of application No. PCT/CN2022/089420, filed on Apr. 27, 2022.

(30) Foreign Application Priority Data
Aug. 11, 2021 (CN) 202110916449.2

(51) Int. Cl. G06Q 10/087

(52) U.S. Cl. CPC G06Q 10/087

(57) ABSTRACT

The present application provides a method, apparatus, electronic device and computer storage medium for assigning goods, and the method includes: obtaining historical order information and forward-looking order information; balancedly assigning each of the goods to a fixed location at each sorting station based on a historical order line quantity of each of the goods in the historical order information; determining a forward-looking order line quantity of the goods in the fixed locations at each of the sorting stations based on the forward-looking order information and the goods information in the fixed locations; and determining the goods to be assigned to motorized locations of each the sorting station based on the forward-looking order line quantity of the goods in the fixed locations at each of the sorting stations. Thus, the problem of uneven workload among operators at different sorting stations is solved, which leads to overall low operational efficiency.

### TECHNICAL FIELD

The present application relates to the field of logistics and warehousing, and more specifically, to a method, apparatus, electronic device and computer storage medium for assigning goods.

### BACKGROUND ART

Splitting and sorting is a common operation mode in logistics warehouses of supermarket chains, drugstores and other retail industries. In splitting and sorting, the operator sorts goods in the sorting station where the goods are assigned in advance. In existing goods assignment methods, goods are mainly assigned to each sorting station based on characteristics such as the category, variety and volume of the goods.

However, due to the fluctuation in the variety and quantity of goods in the demand order, there is often a large gap between the workload of the operators in different sorting stations, and at the same time, some operators in the sorting stations are idle, while some operators in the sorting stations are very busy, and the workload of the operators in the different sorting stations is not balanced, leading to overall operational inefficiency.

### SUMMARY

It is an object of embodiments of the present application to provide a method, apparatus, electronic device and computer storage medium for assigning goods for solving the problem of overall operational inefficiency due to uneven workloads of operators at different sorting stations.

In a first aspect, the present disclosure provides a method for assigning goods, including: obtaining historical order information and forward-looking order information, wherein the historical order information refers to completed order information and the forward-looking order information refers to unexecuted order information; balancedly assigning each of the goods to a fixed location at each sorting station based on a historical order line quantity of each of the goods in the historical order information; wherein the historical order line quantity of each of the goods represents the number of times each of the goods appears in the historical order information; determining a forward-looking order line quantity of the goods in the fixed locations at each of the sorting stations based on the forward-looking order information and the goods information in the fixed locations; and determining the goods to be assigned to motorized locations of each the sorting station based on the forward-looking order line quantity of the goods in the fixed locations at each of the sorting stations.

In embodiments of the present application, goods are assigned to the fixed locations of each sorting station in a balanced manner based on historical order information, so that the workload of each sorting station is balanced over a long period of time. The goods in the motorized locations of each sorting station are determined according to the forward-looking order information, so as to ensure that the workload of each sorting station can be more balanced under the forward-looking order information. By assigning the fixed locations and motorized locations, the workload of each sorting station is balanced, thereby improving the overall work efficiency of all sorting stations.

In an optional embodiment, each of the sorting stations includes multiple fixed locations, the multiple fixed locations include a first fixed location and multiple remaining fixed locations, and each of the fixed locations is arranged for storing one kind of goods; the balancedly assigning each of the goods to a fixed location at each sorting station based on a historical order line quantity of each of the goods in the historical order information includes: determining a historical order line quantity of each of the goods based on the historical order information, and sorting the various goods in descending order according to the historical order line quantity; sequentially assigning a kind of goods to the first fixed location at each the sorting station in order of the historical order line quantity of the goods from largest to smallest; and assigning the remaining goods in a balanced manner to the remaining fixed locations at each the sorting station.

In embodiments of the present application, the more order lines there are, the more times the kind of goods needs to be sorted, and the greater the workload of the operator in sorting the kind of goods, therefore, several kinds of goods corresponding to a greater workload are first assigned to different sorting stations, and then the remaining kinds of goods are assigned balancedly to the remaining fixed locations of the respective sorting stations, so as to make the workload of the respective sorting stations relatively equilibrated.

In an optional embodiment, the assigning the remaining goods in a balanced manner to the remaining fixed locations at each the sorting station includes: determining a first average order line quantity qₐᵥₑ based on the historical order line quantity of each of the goods and a total number of fixed locations at each the sorting station, wherein the first average order line quantity qₐᵥₑ is an average order line quantity averaged over each fixed location at each the sorting station; for one sorting station, performing the following steps: S1: sorting the remaining goods in ascending order of the historical order line quantity; S2: selecting one kind of goods in turn and adding it to the historical order line quantity of the currently assigned goods at the sorting station to obtain qₛᵤₘ; S3: comparing qₛᵤₘ with qₐᵥₑ*(n_{c}+1), if qₛᵤₘ is greater than or equal to qₐᵥₑ*(n_{c}+1), then going to S4; if qₛᵤₘ is less than qₐᵥₑ*(n_{c}+1), then going to S2; if all the remaining goods do not satisfy qₛᵤₘ greater than or equal to qₐᵥₑ*(n_{c}+1), then going to S5; wherein, n_{c} is the number of the fixed locations at the sorting station to which goods have been assigned; S4: assigning the selected goods to one of the remaining fixed locations at the current sorting station, and repeating to S2 until all the remaining fixed locations at the current sorting station have been assigned with goods; S5: assigning the kind of goods with the highest historical order line quantity of all remaining goods to one of the remaining fixed locations at the current sorting station, repeating to S2 until all the remaining fixed locations at the current sorting station have been assigned with goods; and switching to a next sorting station and repeating S1-S5 until all remaining fixed locations at each the sorting station are assigned with goods.

In embodiments of the present application, in assigning the goods to each remaining fixed location, a first average order line quantity qₐᵥₑ for each fixed location at each sorting station is taken into account, thereby ensuring a more balanced workload at each sorting station, and improving the overall efficiency of the sorting station in the subsequent sorting of the orders.

In an optional embodiment, the assigning the remaining goods in a balanced manner to the remaining fixed locations at each the sorting station includes: determining a first average order line quantity qₐᵥₑ based on the historical order line quantity of each of the goods and a total number of fixed locations at each the sorting station, wherein the first average order line quantity qₐᵥₑ is an average order line quantity averaged over each fixed location at each the sorting station; performing the following steps: S1: sorting the remaining goods in ascending order of the historical order line quantity; S2: selecting one kind of goods in turn and adding it to the historical order line quantity of the currently assigned goods at the sorting station to obtain qₛᵤₘ; S3: comparing qₛᵤₘ with qₐᵥₑ*(n_{c}+1), if qₛᵤₘ is greater than or equal to qₐᵥₑ*(n_{c}+1), then going to S4; if qₛᵤₘ is less than qₐᵥₑ*(n_{c}+1), then going to S2; if all the remaining goods do not satisfy qₛᵤₘ greater than or equal to ₐᵥₑ*(n_{c}+1), then going to S5; wherein, n_{c} is the number of the fixed locations at the sorting station to which goods have been assigned; S4: assigning the selected goods to one of the remaining fixed locations at a sorting station, switching to a next sorting station and repeating to S2 until all the remaining fixed locations at each the sorting station have been assigned with goods; and S5: assigning the kind of goods with the highest historical order line quantity of all remaining goods to one of the remaining fixed locations at a sorting station, switching to a next sorting station and repeating to S2 until all the remaining fixed locations at each the sorting station have been assigned with goods.

In an optional embodiment, each of the sorting stations includes multiple fixed locations, the multiple fixed locations includes a first fixed location and multiple remaining fixed locations, and each the fixed location is arranged for storing one kind of goods; the balancedly assigning each of the goods to a fixed location at each sorting station based on a historical order line quantity of each of the goods in the historical order information includes: determining a historical order line quantity of each of the goods based on the historical order information, and sorting the various goods in ascending order according to the historical order line quantity; sequentially assigning a kind of goods to the first fixed location at each the sorting station in order of the historical order line quantity of the goods from smallest to largest; and assigning the remaining goods in a balanced manner to the remaining fixed locations at each the sorting station.

In an optional embodiment, the assigning the remaining goods in a balanced manner to the remaining fixed locations at each the sorting station includes: determining a first average order line quantity qₐᵥₑ based on the historical order line quantity of each of the goods and a total number of fixed locations at each the sorting station, wherein the first average order line quantity qₐᵥₑ is an average order line quantity averaged over each fixed location at each the sorting station; for one sorting station, performing the following steps: S1: sorting the remaining goods in descending order of the historical order line quantity; S2: selecting one kind of goods in turn and adding it to the historical order line quantity of the currently assigned goods at the sorting station to obtain qₛᵤₘ; S3: comparing qₛᵤₘ with qₐᵥₑ*(n_{c}+1), if qₛᵤₘ is less than or equal to qₐᵥₑ*(n_{c}+1), then going to S4; if qₛᵤₘ is greater than qₐᵥₑ*(n_{c}+1), then going to S2; if all the remaining goods do not satisfy qₛᵤₘ less than or equal to ₐᵥₑ*(n_{c}+1), then going to S5; wherein, n_{c} is the number of the fixed locations in the sorting station to which goods have been assigned; S4: assigning the selected goods to one of the remaining fixed locations at the current sorting station, and repeating to S2 until all the remaining fixed locations at the current sorting station have been assigned with goods; S5: assigning the kind of goods with the lowest historical order line quantity of all remaining goods to one of the remaining fixed locations at the current sorting station, repeating to S2 until all the remaining fixed locations at the current sorting station have been assigned with goods; and switching to a next sorting station and repeating S1-S5 until all remaining fixed locations at each the sorting station are assigned with goods.

In an optional embodiment, the assigning the remaining goods in a balanced manner to the remaining fixed locations at each the sorting station includes: determining a first average order line quantity qₐᵥₑ based on the historical order line quantity of each of the goods and a total number of fixed locations at each the sorting station, wherein the first average order line quantity qₐᵥₑ is an average order line quantity averaged over each fixed location at each the sorting station; performing the following steps: S1: sorting the remaining goods in descending order of the historical order line quantity; S2: selecting one kind of goods in turn and adding it to the historical order line quantity of the currently assigned goods at the sorting station to obtain qₛᵤₘ; S3: comparing qₛᵤₘ with qₐᵥₑ*(n_{c}+1), if qₛᵤₘ is less than or equal to qₐᵥₑ*(n_{c}+1), then going to S4; if qₛᵤₘ is greater than qₐᵥₑ*(n_{c}+1), then going to S2; if all the remaining goods do not satisfy qₛᵤₘ less than or equal to ₐᵥₑ*(n_{c}+1), then going to S5; wherein, n_{c} is the number of the fixed locations at the sorting station to which goods have been assigned; S4: assigning the selected goods to one of the remaining fixed locations at a sorting station, switching to a next sorting station and repeating to S2 until all the remaining fixed locations at each the sorting station have been assigned with goods; and S5: assigning the kind of goods with the lowest historical order line quantity of all remaining goods to one of the remaining fixed locations at a sorting station, switching to a next sorting station and repeating to S2 until all the remaining fixed locations at each the sorting station have been assigned with goods.

In an optional embodiment, the determining the goods to be assigned to motorized locations of each the sorting station based on the forward-looking order line quantity of the goods in the fixed locations at each of the sorting stations includes: ranking all the sorting stations according to the size of the order line quantity at each of the sorting stations based on the forward-looking order information, and determining a second average order line quantity at each of the sorting stations; determining a first kind of goods in a first sorting station, wherein the first sorting station is the sorting station having the highest total order line quantity among the sorting station, the first kind of goods has the highest order line quantity at the first sorting station; and assigning the first kind of goods to a motorized location in a second sorting station, and assigning some or all of the order lines corresponding to the first kind of goods to the second sorting station so that a difference between the order line quantity in the first sorting station and the second average order line quantity is less than a predetermined threshold value, and updating the order line quantity in each of the sorting stations, wherein the second sorting station has the lowest order line quantity among the sorting stations; and so on until the difference between the order line quantity of each the sorting station and the second average order line quantity is less than a predetermined threshold value.

In an embodiment of the present application, a kind of goods with the highest order line quantity in a sorting station with the highest order line quantity is assigned to a motorized location in a sorting station with the lowest order line quantity, and the above process is repeated until the difference between the order line quantity of each the sorting station and the second average order line quantity is less than a predetermined threshold value, so as to ensure that the workload of each sorting station is more balanced, thereby increasing the overall efficiency of the splitting and sorting work.

In a second aspect, the present disclosure provides an apparatus for assigning goods, and the apparatus includes: an acquiring module for acquiring historical order information and forward-looking order information, wherein the historical order information refers to completed order information, and the forward-looking order information refers to unexecuted order information; and an assigning module for assigning each kind of goods to a fixed location at each sorting station in a balanced manner according to the historical order line quantity of each kind of goods in the historical order information; wherein the historical order line quantity of each kind of goods indicates the number of times the goods appears in the historical order information; and determining a forward-looking order line quantity of a kind of goods in fixed locations at each sorting station according to the forward-looking order information and the goods information in the fixed location; determining goods to be assigned to a motorized location at each the sorting station based on the forward-looking order line quantity of goods on fixed locations at each the sorting station.

In an optional embodiment, each of the sorting stations includes multiple fixed locations, the multiple fixed locations include a first fixed location and multiple remaining fixed locations, and each the fixed location is arranged for storing one kind of goods; the assigning module is further arranged for determining a historical order line quantity of each of the goods based on the historical order information, and sorting the various goods in descending order according to the historical order line quantity; sequentially assigning a kind of goods to the first fixed location at each the sorting station in order of the historical order line quantity of the goods from largest to smallest; and assigning the remaining goods in a balanced manner to the remaining fixed locations at each the sorting station.

In an optional embodiment, the assigning module is further arranged for determining a first average order line quantity qₐᵥₑ based on the historical order line quantity of each of the goods and a total number of fixed locations at each the sorting station, wherein the first average order line quantity qₐᵥₑ is an average order line quantity averaged over each fixed location at each the sorting station; for one sorting station, performing the following steps: S1: sorting the remaining goods in ascending order of the historical order line quantity; S2: selecting one kind of goods in turn and adding it to the historical order line quantity of the currently assigned goods at the sorting station to obtain qₛᵤₘ; S3: comparing qₛᵤₘ with qₐᵥₑ*(n_{c}+1), if qₛᵤₘ is greater than or equal to qₐᵥₑ*(n_{c}+1), then going to S4; if qₛᵤₘ is less than qₐᵥₑ*(n_{c}+1), then going to S2; if all the remaining goods do not satisfy qₛᵤₘ greater than or equal to qₐᵥₑ*(n_{c}+1), then going to S5; wherein, n_{c} is the number of the fixed locations at the sorting station to which goods have been assigned; S4: assigning the selected goods to one of the remaining fixed locations at the current sorting station, and repeating to S2 until all the remaining fixed locations at the current sorting station have been assigned with goods; S5: assigning the kind of goods with the highest historical order line quantity of all remaining goods to one of the remaining fixed locations at the current sorting station, repeating to S2 until all the remaining fixed locations at the current sorting station have been assigned with goods; and switching to a next sorting station and repeating S1-S5 until all remaining fixed locations at each the sorting station are assigned with goods.

In an optional embodiment, the assigning module is further arranged for determining a first average order line quantity qₐᵥₑ based on the historical order line quantity of each of the goods and a total number of fixed locations at each the sorting station, wherein the first average order line quantity qₐᵥₑ is an average order line quantity averaged over each fixed location at each the sorting station; performing the following steps: S1: sorting the remaining goods in ascending order of the historical order line quantity; S2: selecting one kind of goods in turn and adding it to the historical order line quantity of the currently assigned goods at the sorting station to obtain qₛᵤₘ; S3: comparing qₛᵤₘ with qₐᵥₑ*(n_{c}+1), if qₛᵤₘ is greater than or equal to qₐᵥₑ*(n_{c}+1), then going to S4; if qₛᵤₘ is less than qₐᵥₑ*(n_{c}+1), then going to S2; if all the remaining goods do not satisfy qₛᵤₘ greater than or equal to ₐᵥₑ*(n_{c}+1), then going to S5; wherein, n_{c} is the number of the fixed locations at the sorting station to which goods have been assigned; S4: assigning the selected goods to one of the remaining fixed locations at a sorting station, switching to a next sorting station and repeating to S2 until all the remaining fixed locations at each the sorting station have been assigned with goods; and S5: assigning the kind of goods with the highest historical order line quantity of all remaining goods to one of the remaining fixed locations at a sorting station, switching to a next sorting station and repeating to S2 until all the remaining fixed locations at each the sorting station have been assigned with goods.

In an optional embodiment, each of the sorting stations includes multiple fixed locations, the multiple fixed locations includes a first fixed location and multiple remaining fixed locations, and each the fixed location is arranged for storing one kind of goods; the assigning module is further arranged for determining a historical order line quantity of each of the goods based on the historical order information, and sorting the various goods in ascending order according to the historical order line quantity; sequentially assigning a kind of goods to the first fixed location at each the sorting station in order of the historical order line quantity of the goods from smallest to largest; and assigning the remaining goods in a balanced manner to the remaining fixed locations at each the sorting station.

In an optional embodiment, the assigning module is further arranged for determining a first average order line quantity qₐᵥₑ based on the historical order line quantity of each of the goods and a total number of fixed locations at each the sorting station, wherein the first average order line quantity qₐᵥₑ is an average order line quantity averaged over each fixed location at each the sorting station; for one sorting station, performing the following steps: S1: sorting the remaining goods in descending order of the historical order line quantity; S2: selecting one kind of goods in turn and adding it to the historical order line quantity of the currently assigned goods at the sorting station to obtain qₛᵤₘ; S3: comparing qₛᵤₘ with qₐᵥₑ*(n_{c}+1), if qₛᵤₘ is less than or equal to qₐᵥₑ*(n_{c}+1), then going to S4; if qₛᵤₘ is greater than qₐᵥₑ*(n_{c}+1), then going to S2; if all the remaining goods do not satisfy qₛᵤₘ less than or equal to ₐᵥₑ*(n_{c}+1), then going to S5; wherein, n_{c} is the number of the fixed locations in the sorting station to which goods have been assigned; S4: assigning the selected goods to one of the remaining fixed locations at the current sorting station, and repeating to S2 until all the remaining fixed locations at the current sorting station have been assigned with goods; S5: assigning the kind of goods with the lowest historical order line quantity of all remaining goods to one of the remaining fixed locations at the current sorting station, repeating to S2 until all the remaining fixed locations at the current sorting station have been assigned with goods; and switching to a next sorting station and repeating S1-S5 until all remaining fixed locations at each the sorting station are assigned with goods.

In an optional embodiment, the assigning module is further arranged for determining a first average order line quantity qₐᵥₑ based on the historical order line quantity of each of the goods and a total number of fixed locations at each the sorting station, wherein the first average order line quantity qₐᵥₑ is an average order line quantity averaged over each fixed location at each the sorting station; performing the following steps: S1: sorting the remaining goods in descending order of the historical order line quantity; S2: selecting one kind of goods in turn and adding it to the historical order line quantity of the currently assigned goods at the sorting station to obtain qₛᵤₘ; S3: comparing qₛᵤₘ with qₐᵥₑ*(n_{c}+1), if qₛᵤₘ is less than or equal to qₐᵥₑ*(n_{c}+1), then going to S4; if qₛᵤₘ is greater than qₐᵥₑ*(n_{c}+1), then going to S2; if all the remaining goods do not satisfy qₛᵤₘ less than or equal to ₐᵥₑ*(n_{c}+1), then going to S5; wherein, n_{c} is the number of the fixed locations at the sorting station to which goods have been assigned; S4: assigning the selected goods to one of the remaining fixed locations at a sorting station, switching to a next sorting station and repeating to S2 until all the remaining fixed locations at each the sorting station have been assigned with goods; and S5: assigning the kind of goods with the lowest historical order line quantity of all remaining goods to one of the remaining fixed locations at a sorting station, switching to a next sorting station and repeating to S2 until all the remaining fixed locations at each the sorting station have been assigned with goods.

In an optional embodiment, the assigning module is further arranged for ranking all the sorting stations according to the size of the order line quantity at each of the sorting stations based on the forward-looking order information, and determining a second average order line quantity at each of the sorting stations; determining a first kind of goods in a first sorting station, wherein the first sorting station is the sorting station having the highest total order line quantity among the sorting station, the first kind of goods has the highest order line quantity at the first sorting station; and assigning the first kind of goods to a motorized location in a second sorting station, and assigning some or all of the order lines corresponding to the first kind of goods to the second sorting station so that a difference between the order line quantity in the first sorting station and the second average order line quantity is less than a predetermined threshold value, and updating the order line quantity in each of the sorting stations, wherein the second sorting station has the lowest order line quantity among the sorting stations; and so on until the difference between the order line quantity of each the sorting station and the second average order line quantity is less than a predetermined threshold value.

In a third aspect, the present disclosure provides an electronic device, including: a processor, a memory and a bus; wherein the processor and the memory accomplish communication with each other via the bus; the memory stores program instructions executable by the processor, the processor invokes the program instructions to execute the method as described in any one of the preceding embodiments.

In a fourth aspect, the present disclosure provides a computer storage medium, wherein the computer storage medium is provided with computer instructions, and when the computer instructions are run by a computer, the computer executes the method as described in any of the preceding embodiments.

### DESCRIPTION OF THE ACCOMPANYING DRAWINGS

In order to illustrate the technical solutions of the embodiments of the present application more clearly, the following is a brief introduction to the drawings to be used in the embodiments of the present application. It should be understood that the following drawings only show certain embodiments of the present application, and therefore should not be regarded as limiting the scope of the application, and that a person of ordinary skill in the field can obtain other relevant drawings based on these drawings without making any creative efforts.

FIG. 1 is a flowchart of a method for assigning goods provided in embodiments of the present application.

FIG. 2 is a structural block diagram of an apparatus for assigning goods provided in embodiments of the present application.

FIG. 3 is a structural block diagram of an electronic device provided in embodiments of the present application.

Icons: 200—apparatus for assigning goods; 201—acquiring module; 202—assigning module; 300—electronic device; 301—processor; 302—communication interface; 303—memory; 304—bus.

### DETAILED DESCRIPTION OF THE EMBODIMENTS

The technical solutions in the embodiments of the present application will be described below in conjunction with the accompanying drawings in the embodiments of the present application.

Splitting and sorting is a common operation mode in logistics warehouses of supermarket chains, drugstores and other retail industries. In splitting and sorting, the operator sorts goods in the sorting station where the goods are assigned in advance. In existing goods distribution methods, goods are mainly assigned to each sorting station based on characteristics such as the category, variety, and volume of the goods.

However, due to the fluctuation in the variety and quantity of goods in the demand order, there is often a large gap between the workload of the operators in different sorting stations, and at the same time, some operators in the sorting stations are idle, while some operators in the sorting stations are very busy, and the workload of the operators in the different sorting stations is not balanced, leading to overall operational inefficiency.

Based on the above, embodiments of the present application provide a method, apparatus, electronic device and computer storage medium for assigning goods for solving the above problems.

Embodiments of the present application are described in detail below.

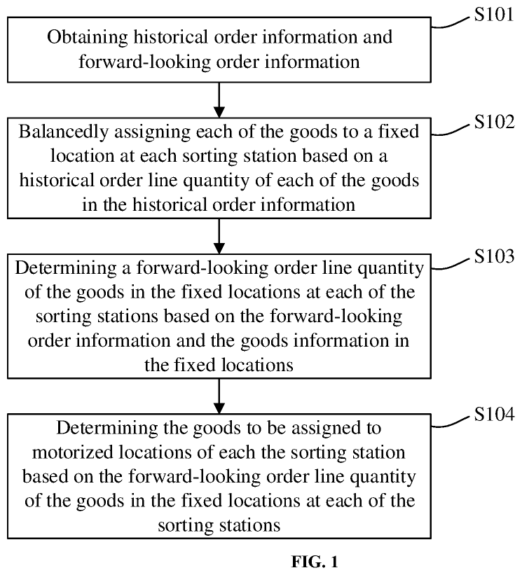

Referring to FIG. 1, FIG. 1 shows a flowchart of a method for assigning goods provided in embodiments of the present application, and the method for assigning goods may include the following steps:

Step S101: obtaining historical order information and forward-looking order information.

Step S102: balancedly assigning each of the goods to a fixed location at each sorting station based on a historical order line quantity of each of the goods in the historical order information.

Step S103: determining a forward-looking order line quantity of the goods in the fixed locations at each of the sorting stations based on the forward-looking order information and the goods information in the fixed locations.

Step S104: determining the goods to be assigned to motorized locations of each the sorting station based on the forward-looking order line quantity of the goods in the fixed locations at each of the sorting stations.

The above process will be described in detail below.

Step S101: obtaining historical order information and forward-looking order information.

In an embodiment of the present application, in order to balance the workload of the operators in each sorting station, it is necessary to assign the goods to each sorting station based on the historical order information and the forward-looking order information. Among them, the historical order information can be the order information of the previous month or the previous week (i.e., the orders that have already been sorted), and the forward-looking order information can be the order information of the next hour or two hours (i.e., the orders that are about to be sorted). It should be noted that the time corresponding to the historical order information can also be the previous two days or the previous three days, and the time corresponding to the forward-looking order information can also be the next three hours or one day, and the application does not make any specific limitations in this regard.

Specifically, the historical order information and the forward-looking order information include the order line information of all the good in the corresponding time of the order. Wherein, an order line corresponds to a kind of goods in an order. For example, if an order involves five kinds of goods, the order has five order lines.

Step S102: balancedly assigning each of the goods to a fixed location at each sorting station based on a historical order line quantity of each of the goods in the historical order information.

In an embodiment of the present application, the order line quantity of the goods in the historical order information indicates the number of times the goods appear in the historical order information. Based on the order line information of each order in the historical order information, the order line quantity for each kind of goods can be determined. The embodiment of the present application proposes two ways to balancedly assign each kind of goods to a fixed location at each sorting station. These two assigning ways are described below.

As an optional embodiment, step S102 may include the following steps: the first step is to determine an order line quantity of each of the goods based on the historical order information, and sort the various goods in descending order according to the historical order line quantity;
the second step is to sequentially assign a kind of goods to the first fixed location at each the sorting station in order of the historical order line quantity of the goods from largest to smallest; and
the third step is to assign the remaining goods in a balanced manner to the remaining fixed locations at each the sorting station.

In the embodiment of the present application, multiple fixed locations are provided at each sorting station, wherein the fixed locations are divided into a first fixed location and multiple remaining fixed locations. Each fixed location is arranged for storing one kind of goods. The goods stored in different fixed locations are different. Each sorting station has the same number of fixed locations. The sum of the number of fixed locations at all sorting stations is not less than the number of goods kinds. For example, if there are 20 kinds of goods and 4 sorting stations, there are at least 5 fixed locations at each sorting station.

Depending on the number of goods kinds, the number of fixed locations at each sorting station can be increased or decreased. Since the size of each sorting station is fixed (i.e., the number of locations is fixed), a different number of locations can be selected as fixed locations depending on the number of goods kinds. For example, if there are 20 kinds of goods in an order and 4 sorting stations, 5 fixed locations are designated for each sorting station to store goods. If there are 24 kinds of goods and 4 sorting stations in the next order information, 6 fixed locations are designated for each sorting station to store goods.

It should be noted that the above first fixed location and the multiple remaining fixed locations are essentially the same, and are only named differently to facilitate the subsequent description.

Specifically, the order line quantity of each kind of goods is first determined based on the historical order information.

By way of example, there are three orders in the historical order information, Order A, Order B, and Order C.

Order A involves Goods 1 and Goods 2, then Order A has two order lines corresponding to Goods 1 and Goods 2.

Order B involves Goods 2, then Order B has one order line corresponding to Goods 2.

Order C involves Goods 1, Goods 2, and Goods 3, then Order B has three order lines corresponding to Goods 1, sorted Goods 2, and Goods 3.

In the historical order information, the order line quantity for Goods 1 is two, the order quantity for Goods 2 is three, and the order line quantity for Goods 3 is one.

After determining the order line quantity for each kind of goods, the multiple kinds of goods are sorted in descending order of their respective order line quantity, and then one kind of the goods is assigned to a first fixed location of each sorting station.

The more order lines there are, the more times the kind of goods needs to be sorted, and the greater the workload of the operator in sorting the kind of goods, therefore, by the above assigning method, several kinds of goods corresponding to a greater workload are first assigned to the first fixed locations of different sorting stations, and then the remaining kinds of goods are assigned balancedly to the remaining fixed locations of the respective sorting stations, so as to make the workload of the respective sorting stations relatively equilibrated.

After the allocation of the first fixed location of each sorting station is completed, the remaining goods will be assigned to the remaining fixed locations of each sorting station in a balanced manner. There are various ways of sorting the remaining fixed locations, and the following two specific embodiment methods will be introduced.

Optionally, the assigning the remaining goods in a balanced manner to the remaining fixed locations at each the sorting station may include:
determining a first average order line quantity qₐᵥₑ based on the historical order line quantity of each of the goods and a total number of fixed locations at each the sorting station, wherein the first average order line quantity qₐᵥₑ is an average order line quantity averaged over each fixed location at each the sorting station.

Specifically, in the historical order information, the order line quantity for each kind of goods can be represented as a set: {q₁, q₂, q₃ . . . qₙ}, and the total number of fixed locations at each sorting station sums up to M, then the first average order line quantity qₐᵥₑ can be expressed as:

$${q}_{ave} = \frac{{q}_{1} , {q}_{2} , {q}_{3} ... ... {q}_{n}}{M}$$

For one sorting station, the following steps are performed:
S1: sorting the remaining goods in ascending order of the historical order line quantity;
S2: selecting one kind of goods in turn and adding it to the historical order line quantity of the currently assigned goods at the sorting station to obtain qₛᵤₘ ;
S3: comparing qₛᵤₘ with qₐᵥₑ*(n_{c}+1), if qₛᵤₘ is greater than or equal to qₐᵥₑ*(n_{c}+1), then going to S4; if qₛᵤₘ is less than qₐᵥₑ*(n_{c}+1), then going to S2; if all the remaining goods do not satisfy qₛᵤₘ greater than or equal to qₐᵥₑ*(n_{c}+1), then going to S5; wherein, n_{c} is the number of the fixed locations at the sorting station to which goods have been assigned;

S4: assigning the selected goods to one of the remaining fixed locations at the current sorting station, and repeating to S2 until all the remaining fixed locations at the current sorting station have been assigned with goods;

S5: assigning the kind of goods with the highest historical order line quantity of all remaining goods to one of the remaining fixed locations at the current sorting station, repeating to S2 until all the remaining fixed locations at the current sorting station have been assigned with goods;

Specifically, a sorting station is selected, and then in order of the order line quantity of the goods from smallest to largest, one kind of goods is selected in turn, the order line quantity of the commodities in the sorting station is selected, and the order line quantity of the kind of goods is added to the order line quantity of the currently assigned goods at the sorting station to obtain qₛᵤₘ. Then qₛᵤₘ continues to be compared to qₐᵥₑ*(n_{c}+1).

Since the goods are selected in ascending order of the order line quantity, the order line quantity of the first selected goods added to the order line quantity of the currently assigned goods at the sorting station yields qₛᵤₘ, which is less than qₐᵥₑ*(n_{c}+1). If the goods corresponding to qₛᵤₘ less than qₐᵥₑ*(n_{c}+1) is assigned to the sorting station, the workload of the sorting station will be less than the average workload, and in subsequent assignments, the workloads of some other sorting stations will be greater than the average workload, resulting in an unbalanced workload. Therefore, the goods corresponding to qₛᵤₘ greater than or equal to qₐᵥₑ*(n_{c+}1) should be assigned to this station. It should be noted that in the process of selecting goods from smallest to largest, it is started with a certain kind of goods, all subsequent goods are determined to have qₛᵤₘ greater than or equal to qₐᵥₑ*(n_{c}+1). In order to equalize the workload at each sorting station, the first kind of goods that satisfies the qₛᵤₘ greater than or equal to qₐᵥₑ*(n_{c}+1) is assigned to a fixed location at that sorting station.

By cycling through the above, the remaining fixed locations at the sorting station are all assigned a kind of goods to be sorted, thereby completing the assignment of the goods to be sorted at the sorting station.

Switching to a next sorting station, S1-S5 are repeated until all remaining fixed locations at each sorting station are assigned with goods.

Specifically, after completing the assignment at one sorting station, the same method as described above is applied to the next sorting station to assign the remaining fixed locations at the next sorting station, and so on, until all the remaining fixed locations at each sorting station are assigned with a kind of goods to be sorted.

With the above sorting method, when assigning goods to each of the remaining fixed locations, the first average order line quantity qₐᵥₑ of each fixed location of each station is taken into account, thereby ensuring a more balanced workload at each sorting station, and improving the overall efficiency of the sorting station in the subsequent sorting of the orders.

Optionally, the assigning the remaining goods in a balanced manner to the remaining fixed locations at each the sorting station may include the following steps:
S1: sorting the remaining goods in ascending order of the historical order line quantity;
S2: selecting one kind of goods in turn and adding it to the historical order line quantity of the currently assigned goods at the sorting station to obtain qₛᵤₘ;
S3: comparing qₛᵤₘ with qₐᵥₑ*(n_{c}+1), if qₛᵤₘ is greater than or equal to qₐᵥₑ*(n_{c}+1), then going to S4; if qₛᵤₘ is less than qₐᵥₑ*(n_{c}+1), then going to S2; if all the remaining goods do not satisfy qₛᵤₘ greater than or equal to ₐᵥₑ*(n_{c}+1), then going to S5; wherein, n_{c} is the number of the fixed locations at the sorting station to which goods have been assigned;
S4: assigning the selected goods to one of the remaining fixed locations at a sorting station, switching to a next sorting station and repeating to S2 until all the remaining fixed locations at each the sorting station have been assigned with goods;
S5: assigning the kind of goods with the highest historical order line quantity of all remaining goods to one of the remaining fixed locations at a sorting station, switching to a next sorting station and repeating to S2 until all the remaining fixed locations at each the sorting station have been assigned with goods. It should be noted that the logic of this embodiment is the same as that of the previous embodiment in terms of assigning goods to each of the fixed locations, but the difference is that in the previous embodiment, all the remaining fixed locations in one sorting station are assigned first, and then the remaining fixed locations in the next sorting station are assigned, and so on, until all the remaining fixed locations in all the sorting stations are assigned. The present embodiment, on the other hand, sequentially assigns one remaining fixed location at each sorting station, then assigns another remaining fixed location at each sorting station, and so on, until each remaining fixed location at all sorting stations has been assigned.

For example, there are four sorting stations, and each sorting station has three remaining fixed locations, that is, a first remaining fixed location, a second remaining fixed location, and a third remaining fixed location. In this embodiment, the first remaining fixed locations of the four sorting stations are first assigned, and after the assignment is completed, the second remaining fixed locations of the four sorting stations are assigned, and finally, the third remaining fixed locations of the four sorting stations are assigned, and the assignment is finally completed. In the previous embodiment, the assignment is completed for the three remaining locations in one sorting station, then the assignment is completed for the three remaining locations in another sorting station, and so on until all four sorting stations have been assigned.

As another optional embodiment, step S102 may include the following steps:
the first step is to determine an order line quantity of each of the goods based on the historical order information, and sort the various goods in ascending order according to the historical order line quantity;
the second step is to sequentially assign a kind of goods to the first fixed location at each the sorting station in order of the historical order line quantity of the goods from smallest to largest; and
the third step is to assign the remaining goods in a balanced manner to the remaining fixed locations at each the sorting station.

It should be noted that, in the previous embodiment, when assigning the fixed locations, some kinds of goods to be sorted which correspond to a larger workload are first assigned to different sorting stations, and then the remaining goods to be sorted are assigned to the remaining fixed locations of each sorting station in a balanced manner. In the present embodiment, on the contrary, some kinds of goods to be sorted which correspond to a smaller workload are first assigned to the first fixed locations of different sorting stations, and then the remaining goods to be sorted are assigned to the remaining fixed locations of each sorting station in a balanced manner. After the assignment of the first fixed location is completed, the same as the aforementioned embodiment method, when assigning the goods to the remaining fixed locations, there are also two embodiment methods, namely: after all the remaining fixed locations of a sorting station are assigned, then the remaining fixed locations of the next sorting station are assigned, and so on, until every remaining fixed location of all the sorting stations is assigned; or one remaining fixed location of each sorting station is assigned in turn, then another remaining fixed location at each sorting station are assigned, and so on, until each remaining fixed location at all sorting stations is assigned.

For the two kinds of assignments for the remaining fixed location, the specific processed are as follows:

As a first embodiment, the assigning the remaining goods in a balanced manner to the remaining fixed locations at each the sorting station may include:
for one sorting station, performing the following steps:
S1: sorting the remaining goods in descending order of the historical order line quantity; S2: selecting one kind of goods in turn and adding it to the historical order line quantity of the currently assigned goods at the sorting station to obtain qₛᵤₘ;
S3: comparing qₛᵤₘ with qₐᵥₑ*(n_{c}+1), if qₛᵤₘ is less than or equal to qₐᵥₑ*(n_{c}+1), then going to S4; if qₛᵤₘ is greater than qₐᵥₑ*(n_{c}+1), then going to S2; if all the remaining goods do not satisfy qₛᵤₘ less than or equal to ₐᵥₑ*(n_{c}+1), then going to S5; wherein, n_{c} is the number of the fixed locations in the sorting station to which goods have been assigned;
S4: assigning the selected goods to one of the remaining fixed locations at the current sorting station, and repeating to S2 until all the remaining fixed locations at the current sorting station have been assigned with goods;
S5: assigning the kind of goods with the lowest historical order line quantity of all remaining goods to one of the remaining fixed locations at the current sorting station, repeating to S2 until all the remaining fixed locations at the current sorting station have been assigned with goods;

and switching to a next sorting station and repeating S1-S5 until all remaining fixed locations at each the sorting station are assigned with goods.

As a second embodiment, the assigning the remaining goods in a balanced manner to the remaining fixed locations at each the sorting station may include:
S1: sorting the remaining goods in descending order of the historical order line quantity; S2: selecting one kind of goods in turn and adding it to the historical order line quantity of the currently assigned goods at the sorting station to obtain qₛᵤₘ;
S3: comparing qₛᵤₘ with qₐᵥₑ*(n_{c}+1), if qₛᵤₘ is less than or equal to qₐᵥₑ*(n_{c}+1), then going to S4; if qₛᵤₘ is greater than qₐᵥₑ*(n_{c}+1), then going to S2; if all the remaining goods do not satisfy qₛᵤₘ less than or equal to ₐᵥₑ*(n_{c}+1), then going to S5; wherein, n_{c} is the number of the fixed locations at the sorting station to which goods have been assigned;
S4: assigning the selected goods to one of the remaining fixed locations at a sorting station, switching to a next sorting station and repeating to S2 until all the remaining fixed locations at each the sorting station have been assigned with goods; and
S5: assigning the kind of goods with the lowest historical order line quantity of all remaining goods to one of the remaining fixed locations at a sorting station, switching to a next sorting station and repeating to S2 until all the remaining fixed locations at each the sorting station have been assigned with goods.

In the present application embodiments, the two assignment methods for assigning goods to the remaining fixed locations correspond to the two assignment methods in the preceding embodiments, and for the sake of brevity of the specification, the same or similar parts can be cross-referenced and will not be repeated here.

For ease of description, steps S103 and S104 are described together below.
Step S103: determining a forward-looking order line quantity of the goods in the fixed locations at each of the sorting stations based on the forward-looking order information and the goods information in the fixed locations.
Step S104: determining the goods to be assigned to motorized locations of each the sorting station based on the forward-looking order line quantity of the goods in the fixed locations at each of the sorting stations.

In the embodiment of the present application, the goods are evenly assigned to the fixed locations at each sorting station based on the historical order information, and since the historical order information corresponds to the order contents of the previous month or the previous week, and contains order information for a long period of time, the method of determining the assignment of the goods to each fixed location based on the historical order information makes it possible to equalize the workload of each sorting station for a relatively long period of time. However, since the frequency of occurrence of the various kinds of goods in the forward-looking order information may differ from the frequency of occurrence of the various kinds of goods in the historical order information, the workload of each sorting station may vary over a short period of time (e.g., within an hour or a few hours).

Therefore, in order to balance the workload of each sorting station over a short period of time, embodiments of the present application set up motorized locations in addition to fixed locations at each sorting station.

Since there is a difference between the forward-looking order information and the historical order information, based on the forward-looking order information and the current assignment of fixed locations at each sorting station, it is possible to determine the line quantity of goods at each sorting station under the forward-looking order, and then based on the line quantity of goods at each sorting station, the goods are assigned to the motorized locations at each sorting station, thereby balancing the workload of each sorting station.

As an optional embodiment, step S104 may include the following steps:
The first step is to rank all the sorting stations according to the size of the order line quantity at each of the sorting stations based on the forward-looking order information, and determine a second average order line quantity at each of the sorting stations.

Specifically, the sorting stations are sorted by the order line quantity under the forward-looking order information from largest to smallest, and a second average order line quantity is determined for each sorting station based on the forward-looking order information. Wherein the second average order line quantity is the total order line quantity in the forward-looking order divided by the number of sorting stations.

The second step is to determine a first kind of goods in a first sorting station, wherein the first sorting station is the sorting station having the highest total order line quantity among the sorting station, the first kind of goods has the highest order line quantity at the first sorting station.

The third step is to assign the first kind of goods to a motorized location in a second sorting station, and assign some or all of the order lines corresponding to the first kind of goods to the second sorting station so that a difference between the order line quantity in the first sorting station and the second average order line quantity is less than a predetermined threshold value, and update the order line quantity in each of the sorting stations, wherein the second sorting station has the lowest order line quantity among the sorting stations; and so on until the difference between the order line quantity of each the sorting station and the second average order line quantity is less than a predetermined threshold value.

In an embodiment of the present application, based on the forward-looking order information, a first sorting station with the highest order line quantity among the sorting stations and a first kind of goods with the highest order line quantity among the first sorting stations are determined. The first kind of goods is assigned to a motorized location of a second sorting station that has the lowest order line quantity among the sorting stations, and a portion of the order lines corresponding to the first kind of goods is assigned to the second sorting station, and the order line quantity of each sorting station is then updated.

The above method is repeated until the difference between the order line quantity of each sorting station and the second average order line quantity is less than the predetermined threshold. Since the goods are different from one fixed location to another, it may not be possible to make the order line quantity at each sorting station exactly the same as the second average order line quantity (i.e., the workload at each sorting station is exactly the same) after assigning the motorized locations. Therefore, a predetermined threshold is set such that when the difference between the order line quantity of each sorting station and the second average order line quantity is less than the predetermined threshold, the current workload of each sorting station is considered to be balanced.

It should be noted that the number of motorized locations may be one or more, and the present application does not specifically limit the number of motorized locations, which may be selected according to the actual situation of the goods.

By the above method, a kind of goods with the highest order line quantity in a sorting station with the highest order line quantity is assigned to a motorized location in a sorting station with the lowest order line quantity, and the above process is repeated until the difference between the order line quantity of each the sorting station and the second average order line quantity is less than a predetermined threshold value, so as to ensure that the workload of each sorting station is more balanced, thereby increasing the overall efficiency of the splitting and sorting work.

Embodiments of the present application provide a method for assigning goods, whereby goods are assigned to fixed locations at each sorting station in a balanced manner according to historical order information, so as to realize that the workload of each sorting station can be balanced over a long period of time. Based on the forward-looking order information, the goods in the motorized locations of each sorting station are determined to ensure that the workload of each sorting station can be balanced under the forward-looking order information. Through the assignment of fixed locations and motorized locations, the workload of each sorting station is balanced, thereby improving the overall work efficiency of all sorting stations.

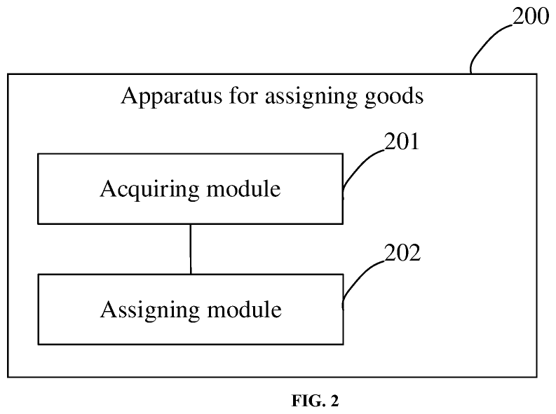

Based on the same inventive concept, an embodiment of the present application also provides an apparatus for assigning goods. Referring to FIG. 2, FIG. 2 shows a structural block diagram of an apparatus for assigning goods provided by the embodiment of the present application, and the apparatus for assigning goods 200 includes:
an acquiring module for acquiring historical order information and forward-looking order information, wherein the historical order information refers to completed order information, and the forward-looking order information refers to unexecuted order information;
an assigning module for assigning each kind of goods to a fixed location at each sorting station in a balanced manner according to the historical order line quantity of each kind of goods in the historical order information; wherein the historical order line quantity of each kind of goods indicates the number of times the goods appears in the historical order information; and determining a forward-looking order line quantity of a kind of goods in fixed locations at each sorting station according to the forward-looking order information and the goods information in the fixed location; determining goods to be assigned to a motorized location at each the sorting station based on the forward-looking order line quantity of goods on fixed locations at each the sorting station.

In an optional embodiment, each of the sorting stations includes multiple fixed locations, the multiple fixed locations include a first fixed location and multiple remaining fixed locations, and each the fixed location is arranged for storing one kind of goods; the assigning module is further arranged for determining a historical order line quantity of each of the goods based on the historical order information, and sorting the various goods in descending order according to the historical order line quantity; sequentially assigning a kind of goods to the first fixed location at each the sorting station in order of the historical order line quantity of the goods from largest to smallest; and assigning the remaining goods in a balanced manner to the remaining fixed locations at each the sorting station.

In an optional embodiment, the assigning module 202 is further arranged for determining a first average order line quantity qₐᵥₑ based on the historical order line quantity of each of the goods and a total number of fixed locations at each the sorting station, wherein the first average order line quantity qₐᵥₑ is an average order line quantity averaged over each fixed location at each the sorting station; for one sorting station, performing the following steps: S1: sorting the remaining goods in ascending order of the historical order line quantity; S2: selecting one kind of goods in turn and adding it to the historical order line quantity of the currently assigned goods at the sorting station to obtain qₛᵤₘ; S3: comparing qₛᵤₘ with qₐᵥₑ*(n_{c}+1), if qₛᵤₘ is greater than or equal to qₐᵥₑ*(n_{c}+1), then going to S4; if qₛᵤₘ is less than qₐᵥₑ*(n_{c}+1), then going to S2; if all the remaining goods do not satisfy qₛᵤₘ greater than or equal to qₐᵥₑ*(n_{c}+1), then going to S5; wherein, n_{c} is the number of the fixed locations at the sorting station to which goods have been assigned; S4: assigning the selected goods to one of the remaining fixed locations at the current sorting station, and repeating to S2 until all the remaining fixed locations at the current sorting station have been assigned with goods; S5: assigning the kind of goods with the highest historical order line quantity of all remaining goods to one of the remaining fixed locations at the current sorting station, repeating to S2 until all the remaining fixed locations at the current sorting station have been assigned with goods; and switching to a next sorting station and repeating S1-S5 until all remaining fixed locations at each the sorting station are assigned with goods.

In an optional embodiment, the assigning module 202 is further arranged for determining a first average order line quantity qₐᵥₑ based on the historical order line quantity of each of the goods and a total number of fixed locations at each the sorting station, wherein the first average order line quantity qₐᵥₑ is an average order line quantity averaged over each fixed location at each the sorting station; performing the following steps: S1: sorting the remaining goods in ascending order of the historical order line quantity; S2: selecting one kind of goods in turn and adding it to the historical order line quantity of the currently assigned goods at the sorting station to obtain qₛᵤₘ; S3: comparing qₛᵤₘ with qₐᵥₑ*(n_{c}+1), if qₛᵤₘ is greater than or equal to qₐᵥₑ*(n_{c}+1), then going to S4; if qₛᵤₘ is less than qₐᵥₑ*(n_{c}+1), then going to S2; if all the remaining goods do not satisfy qₛᵤₘ greater than or equal to ₐᵥₑ*(n_{c}+1), then going to S5; wherein, n_{c} is the number of the fixed locations at the sorting station to which goods have been assigned; S4: assigning the selected goods to one of the remaining fixed locations at a sorting station, switching to a next sorting station and repeating to S2 until all the remaining fixed locations at each the sorting station have been assigned with goods; and S5: assigning the kind of goods with the highest historical order line quantity of all remaining goods to one of the remaining fixed locations at a sorting station, switching to a next sorting station and repeating to S2 until all the remaining fixed locations at each the sorting station have been assigned with goods.

In an optional embodiment, each of the sorting stations includes multiple fixed locations, the multiple fixed locations includes a first fixed location and multiple remaining fixed locations, and each the fixed location is arranged for storing one kind of goods; the assigning module is further arranged for determining a historical order line quantity of each of the goods based on the historical order information, and sorting the various goods in ascending order according to the historical order line quantity; sequentially assigning a kind of goods to the first fixed location at each the sorting station in order of the historical order line quantity of the goods from smallest to largest; and assigning the remaining goods in a balanced manner to the remaining fixed locations at each the sorting station.

In an optional embodiment, the assigning module 202 is further arranged for determining a first average order line quantity qₐᵥₑ based on the historical order line quantity of each of the goods and a total number of fixed locations at each the sorting station, wherein the first average order line quantity qₐᵥₑ is an average order line quantity averaged over each fixed location at each the sorting station; for one sorting station, performing the following steps: S1: sorting the remaining goods in descending order of the historical order line quantity; S2: selecting one kind of goods in turn and adding it to the historical order line quantity of the currently assigned goods at the sorting station to obtain qₛᵤₘ; S3: comparing qₛᵤₘ with qₐᵥₑ*(n_{c}+1), if qₛᵤₘ is less than or equal to qₐᵥₑ*(n_{c}+1), then going to S4; if qₛᵤₘ is greater than qₐᵥₑ*(n_{c}+1), then going to S2; if all the remaining goods do not satisfy qₛᵤₘ less than or equal to ₐᵥₑ*(n_{c}+1), then going to S5; wherein, n_{c} is the number of the fixed locations in the sorting station to which goods have been assigned; S4: assigning the selected goods to one of the remaining fixed locations at the current sorting station, and repeating to S2 until all the remaining fixed locations at the current sorting station have been assigned with goods; S5: assigning the kind of goods with the lowest historical order line quantity of all remaining goods to one of the remaining fixed locations at the current sorting station, repeating to S2 until all the remaining fixed locations at the current sorting station have been assigned with goods; and switching to a next sorting station and repeating S1-S5 until all remaining fixed locations at each the sorting station are assigned with goods.

In an optional embodiment, the assigning module 202 is further arranged for determining a first average order line quantity qₐᵥₑ based on the historical order line quantity of each of the goods and a total number of fixed locations at each the sorting station, wherein the first average order line quantity qₐᵥₑ is an average order line quantity averaged over each fixed location at each the sorting station; performing the following steps: S1: sorting the remaining goods in descending order of the historical order line quantity; S2: selecting one kind of goods in turn and adding it to the historical order line quantity of the currently assigned goods at the sorting station to obtain qₛᵤₘ; S3: comparing qₛᵤₘ with qₐᵥₑ*(n_{c}+1), if qₛᵤₘ is less than or equal to qₐᵥₑ*(n_{c}+1), then going to S4; if qₛᵤₘ is greater than qₐᵥₑ*(n_{c}+1), then going to S2; if all the remaining goods do not satisfy qₛᵤₘ less than or equal to ₐᵥₑ*(n_{c}+1), then going to S5; wherein, n_{c} is the number of the fixed locations at the sorting station to which goods have been assigned; S4: assigning the selected goods to one of the remaining fixed locations at a sorting station, switching to a next sorting station and repeating to S2 until all the remaining fixed locations at each the sorting station have been assigned with goods; and S5: assigning the kind of goods with the lowest historical order line quantity of all remaining goods to one of the remaining fixed locations at a sorting station, switching to a next sorting station and repeating to S2 until all the remaining fixed locations at each the sorting station have been assigned with goods.

In an optional embodiment, assigning module is further arranged for ranking all the sorting stations according to the size of the order line quantity at each of the sorting stations based on the forward-looking order information, and determining a second average order line quantity at each of the sorting stations; determining a first kind of goods in a first sorting station, wherein the first sorting station is the sorting station having the highest total order line quantity among the sorting station, the first kind of goods has the highest order line quantity at the first sorting station; and assigning the first kind of goods to a motorized location in a second sorting station, and assigning some or all of the order lines corresponding to the first kind of goods to the second sorting station so that a difference between the order line quantity in the first sorting station and the second average order line quantity is less than a predetermined threshold value, and updating the order line quantity in each of the sorting stations, wherein the second sorting station has the lowest order line quantity among the sorting stations; and so on until the difference between the order line quantity of each the sorting station and the second average order line quantity is less than a predetermined threshold value.

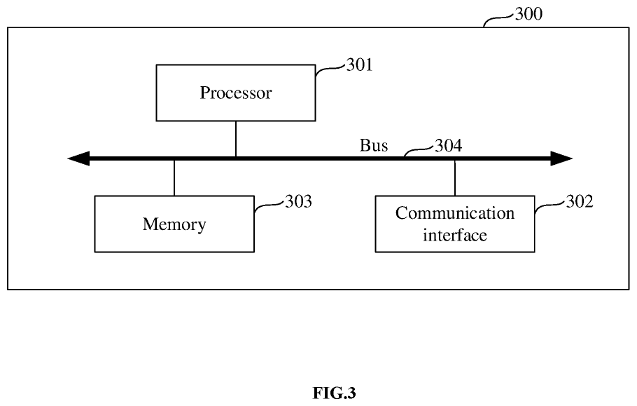

Referring to FIG. 3, FIG. 3 is a structural block diagram of an electronic device 300 of an embodiment of the present application, which includes: at least one processor 301, at least one communication interface 302, at least one memory 303, and at least one bus 304, wherein the bus 304 is arranged to realize the direct connection and communication of these components, the communication interface 302 is arranged for signaling or data communication with other nodes, and the memory 303 stores machine-readable instructions executable by the processor 301. When the electronic device 300 is in operation, the processor 301 communicates with the memory 303 via the bus 304, and the machine-readable instructions are invoked by the processor 301 to execute the method for assigning goods described above.

The processor 301 may be an integrated circuit chip with signal processing capability. The above processor 301 may be a general-purpose processor, including a central processing unit (CPU), network processor (NP), etc.; it may also be a digital signal processing (DSP), application specific integrated circuit (ASIC), field-programmable gate array (FPGA) or other programmable logic device, discrete component gate or transistor logic component, or discrete hardware component. It may implement or perform the various methods, steps, and logic block diagrams disclosed in the embodiments of the present application. The general-purpose processor may be a microprocessor or the processor may be any conventional processor, etc.

Memory 303 may include, but is not limited to, random access memory (RAM), read-only memory (ROM), programmable read-only memory (PROM), erasable programmable read-only memory (EPROM), electric erasable programmable read-only memory (EEPROM), etc.

It will be appreciated that the structure shown in FIG. 3 is illustrative only, and that the electronic device 300 may also include more or fewer components than shown in FIG. 3, or have a different configuration than shown in FIG. 3. The components shown in FIG. 3 may be implemented using hardware, software, or a combination thereof. In embodiments of the present application, the electronic device 300 may be, but is not limited to, a physical device such as a desktop computer, a laptop computer, a smart phone, a smart wearable device, an in-vehicle device, or a virtual device such as a virtual machine. In addition, the electronic device 300 may not necessarily be a single device, but may be a combination of multiple devices, such as a server cluster, and the like.

In addition, embodiments of the present application also provide a computer storage medium on which a computer program is stored. When the computer program is run by the computer, the steps of a method for assigning goods described in the above embodiments are executed.

In the embodiments provided in this application, it should be understood that the disclosed apparatus and method may be realized in other ways. The above-described embodiments of the apparatus are merely illustrative; for example, the division of the units described is merely a logical functional division, and may be implemented in a different manner, or, for example, multiple units or components may be combined or integrated into another system, or some features may be ignored, or not implemented. Alternatively, the coupling or direct coupling or communication connection shown or discussed between each other may be indirect coupling or communication connection through some communication interface, device, or unit, and may be electrical, mechanical, or otherwise.

Furthermore, the units illustrated as separate components may or may not be physically separated, and the components shown as units may or may not be physical units, i.e., they may be located in a single place or may be distributed over a number of network units. Some or all of the units can be selected according to the actual needs to achieve the purpose of the embodiment.

Further, the functional modules in each embodiment of the present application may be integrated together to form an independent part, or each module may exist separately, or two or more modules may be integrated to form an independent part.

It should be noted that the functions may be stored in a computer-readable storage medium if they are implemented in the form of software function modules and sold or used as a separate product. With this understanding, the technical solution of the present application, in essence or as a contribution to the prior art, or portions of the technical solution, may be embodied in the form of a software product that is stored on a storage medium and includes a number of instructions to cause a computer device (which may be a personal computer, a server, a network device, etc.) to perform all or some of the steps of the method described in various embodiments of the present application. The aforementioned storage medium includes USB flash drives, removable hard disks, read-only memory (ROM), random access memory (RAM), magnetic disks, or CD-ROMs, and other media on which the program code can be stored.

As used herein, relational terms such as first and second are used only to distinguish one entity or operation from another, and do not necessarily require or imply any such actual relationship or order between those entities or operations.

The foregoing is merely embodiments of the present application and is not intended to limit the scope of protection of the present application, which may be subject to various changes and variations by a person skilled in the art. Any modifications, equivalent substitutions, improvements, etc. made within the spirit and principles of this application shall be included in the scope of protection of this application.

What is claimed is:

1. A method for assigning goods, characterized in that it comprises:
obtaining historical order information and forward-looking order information, wherein the historical order information refers to completed order information and the forward-looking order information refers to unexecuted order information; balancedly assigning each of the goods to a fixed location at each sorting station based on a historical order line quantity of each of the goods in the historical order information; wherein the historical order line quantity of each of the goods represents the number of times each of the goods appears in the historical order information;
determining a forward-looking order line quantity of the goods in the fixed locations at each of the sorting stations based on the forward-looking order information and the goods information in the fixed locations; and determining the goods to be assigned to motorized locations of each the sorting station based on the forward-looking order line quantity of the goods in the fixed locations at each of the sorting stations.

2. The method according to claim 1, characterized in that each of the sorting stations comprises a plurality of fixed locations, the plurality of fixed locations comprises a first fixed location and a plurality of remaining fixed locations, and each the fixed location is arranged for storing one kind of goods; the balancedly assigning each of the goods to a fixed location at each sorting station based on a historical order line quantity of each of the goods in the historical order information comprises:
determining a historical order line quantity of each of the goods based on the historical order information, and sorting the various goods in descending order according to the historical order line quantity; sequentially assigning a kind of goods to the first fixed location at each the sorting station in order of the historical order line quantity of the goods from largest to smallest; and assigning the remaining goods in a balanced manner to the remaining fixed locations at each the sorting station.

3. The method according to claim 2, characterized in that the assigning the remaining goods in a balanced manner to the remaining fixed locations at each the sorting station comprises:
determining a first average order line quantity qₐᵥₑ based on the historical order line quantity of each of the goods and a total number of fixed locations at each the sorting station, wherein the first average order line quantity qₐᵥₑ is an average order line quantity averaged over each fixed location at each the sorting station;
for one sorting station, performing the following steps:
S1: sorting the remaining goods in ascending order of the historical order line quantity;
S2: selecting one kind of goods in turn and adding it to the historical order line quantity of the currently assigned goods at the sorting station to obtain qₛᵤₘ;
S3: comparing qₛᵤₘ with qₐᵥₑ*(n_{c}+1), if qₛᵤₘ is greater than or equal to qₐᵥₑ*(n_{c}+1), then going to S4; if qₛᵤₘ is less than qₐᵥₑ*(n_{c}+1), then going to S2; if all the remaining goods do not satisfy qₛᵤₘ greater than or equal to qₐᵥₑ*(n_{c}+1), then going to S5; wherein, n_{c} is the number of the fixed locations at the sorting station to which goods have been assigned;
S4: assigning the selected goods to one of the remaining fixed locations at the current sorting station, and repeating to S2 until all the remaining fixed locations at the current sorting station have been assigned with goods;
S5: assigning the kind of goods with the highest historical order line quantity of all remaining goods to one of the remaining fixed locations at the current sorting station, repeating to S2 until all the remaining fixed locations at the current sorting station have been assigned with goods; switching to a next sorting station and repeating S1-S5 until all remaining fixed locations at each the sorting station are assigned with goods.

4. The method according to claim 2, characterized in that the assigning the remaining goods in a balanced manner to the remaining fixed locations at each the sorting station comprises:
determining a first average order line quantity qₐᵥₑ based on the historical order line quantity of each of the goods and a total number of fixed locations at each the sorting station, wherein the first average order line quantity qₐᵥₑ is an average order line quantity averaged over each fixed location at each the sorting station;
performing the following steps:
S1: sorting the remaining goods in ascending order of the historical order line quantity;
S2: selecting one kind of goods in turn and adding it to the historical order line quantity of the currently assigned goods at the sorting station to obtain qₛᵤₘ;
S3: comparing qₛᵤₘ with qₐᵥₑ*(n_{c}+1), if qₛᵤₘ is greater than or equal to qₐᵥₑ*(n_{c}+1), then going to S4; if qₛᵤₘ is less than qₐᵥₑ*(n_{c}+1), then going to S2; if all the remaining goods do not satisfy qₛᵤₘ greater than or equal to ₐᵥₑ*(n_{c}+1), then going to S5; wherein, n_{c} is the number of the fixed locations at the sorting station to which goods have been assigned;
S4: assigning the selected goods to one of the remaining fixed locations at a sorting station, switching to a next sorting station and repeating to S2 until all the remaining fixed locations at each the sorting station have been assigned with goods;
S5: assigning the kind of goods with the highest historical order line quantity of all remaining goods to one of the remaining fixed locations at a sorting station, switching to a next sorting station and repeating to S2 until all the remaining fixed locations at each the sorting station have been assigned with goods.

5. The method according to claim 1, characterized in that each of the sorting stations comprises a plurality of fixed locations, the plurality of fixed locations comprises a first fixed location and a plurality of remaining fixed locations, and each the fixed location is arranged for storing one kind of goods; the balancedly assigning each of the goods to a fixed location at each sorting station based on a historical order line quantity of each of the goods in the historical order information comprises:
determining a historical order line quantity of each of the goods based on the historical order information, and sorting the various goods in ascending order according to the historical order line quantity; sequentially assigning a kind of goods to the first fixed location at each the sorting station in order of the historical order line quantity of the goods from smallest to largest; and assigning the remaining goods in a balanced manner to the remaining fixed locations at each the sorting station.

6. The method according to claim 5, characterized in that the assigning the remaining goods in a balanced manner to the remaining fixed locations at each the sorting station comprises:
determining a first average order line quantity qₐᵥₑ based on the historical order line quantity of each of the goods and a total number of fixed locations at each the sorting station, wherein the first average order line quantity qₐᵥₑ is an average order line quantity averaged over each fixed location at each the sorting station;
for one sorting station, performing the following steps:
S1: sorting the remaining goods in descending order of the historical order line quantity;
S2: selecting one kind of goods in turn and adding it to the historical order line quantity of the currently assigned goods at the sorting station to obtain qₛᵤₘ;
S3: comparing qₛᵤₘ with qₐᵥₑ*(n_{c}+1), if qₛᵤₘ is less than or equal to qₐᵥₑ*(n_{c}+1), then going to S4; if qₛᵤₘ is greater than qₐᵥₑ*(n_{c}+1), then going to S2; if all the remaining goods do not satisfy qₛᵤₘ less than or equal to ₐᵥₑ*(n_{c}+1), then going to S5; wherein, n_{c} is the number of the fixed locations in the sorting station to which goods have been assigned;
S4: assigning the selected goods to one of the remaining fixed locations at the current sorting station, and repeating to S2 until all the remaining fixed locations at the current sorting station have been assigned with goods;
S5: assigning the kind of goods with the lowest historical order line quantity of all remaining goods to one of the remaining fixed locations at the current sorting station, repeating to S2 until all the remaining fixed locations at the current sorting station have been assigned with goods; switching to a next sorting station and repeating S1-S5 until all remaining fixed locations at each the sorting station are assigned with goods.

7. The method according to claim 2, characterized in that the assigning the remaining goods in a balanced manner to the remaining fixed locations at each the sorting station comprises:
determining a first average order line quantity qₐᵥₑ based on the historical order line quantity of each of the goods and a total number of fixed locations at each the sorting station, wherein the first average order line quantity qₐᵥₑ is an average order line quantity averaged over each fixed location at each the sorting station;
performing the following steps:
S1: sorting the remaining goods in descending order of the historical order line quantity;
S2: selecting one kind of goods in turn and adding it to the historical order line quantity of the currently assigned goods at the sorting station to obtain qₛᵤₘ;
S3: comparing qₛᵤₘ with qₐᵥₑ*(n_{c}+1), if qₛᵤₘ is less than or equal to qₐᵥₑ*(n_{c}+1), then going to S4; if qₛᵤₘ is greater than qₐᵥₑ*(n_{c}+1), then going to S2; if all the remaining goods do not satisfy qₛᵤₘ less than or equal to ₐᵥₑ*(n_{c}+1), then going to S5; wherein, n_{c} is the number of the fixed locations at the sorting station to which goods have been assigned;
S4: assigning the selected goods to one of the remaining fixed locations at a sorting station, switching to a next sorting station and repeating to S2 until all the remaining fixed locations at each the sorting station have been assigned with goods;
S5: assigning the kind of goods with the lowest historical order line quantity of all remaining goods to one of the remaining fixed locations at a sorting station, switching to a next sorting station and repeating to S2 until all the remaining fixed locations at each the sorting station have been assigned with goods.

8. The method according to claim 1, characterized in that the determining the goods to be assigned to motorized locations of each the sorting station based on the forward-looking order line quantity of the goods in the fixed locations at each of the sorting stations comprises:
ranking all the sorting stations according to the size of the order line quantity at each of the sorting stations based on the forward-looking order information, and determining a second average order line quantity at each of the sorting stations;
determining a first kind of goods in a first sorting station, wherein the first sorting station is the sorting station having the highest total order line quantity among the sorting station, the first kind of goods has the highest order line quantity at the first sorting station; and
assigning the first kind of goods to a motorized location in a second sorting station, and assigning some or all of the order lines corresponding to the first kind of goods to the second sorting station so that a difference between the order line quantity in the first sorting station and the second average order line quantity is less than a predetermined threshold value, and updating the order line quantity in each of the sorting stations, wherein the second sorting station has the lowest order line quantity among the sorting stations; and so on until the difference between the order line quantity of each the sorting station and the second average order line quantity is less than a predetermined threshold value.

9. An apparatus for assigning goods, characterized in that the apparatus comprises:
an acquiring module for acquiring historical order information and forward-looking order information, wherein the historical order information refers to completed order information, and the forward-looking order information refers to unexecuted order information;
an assigning module for assigning each kind of goods to a fixed location at each sorting station in a balanced manner according to the historical order line quantity of each kind of goods in the historical order information; wherein the historical order line quantity of each kind of goods indicates the number of times the goods appears in the historical order information; and determining a forward-looking order line quantity of a kind of goods in fixed locations at each sorting station according to the forward-looking order information and the goods information in the fixed location; determining goods to be assigned to a motorized location at each the sorting station based on the forward-looking order line quantity of goods on fixed locations at each the sorting station.

10. An electronic device, characterized in that it comprises: a processor, a memory and a bus;
wherein the processor and the memory accomplish communication with each other via the bus; the memory stores program instructions executable by the processor, the processor invokes the program instructions to execute the method as claimed in claim 1.

11. A computer storage medium, characterized in that the computer storage medium is provided with computer instructions, and when the computer instructions are run by a computer, the computer executes the method as claimed in claim 1.
